(19) United States
(12) Patent Application Publication
(10) Pub. No.: US 2012/0030746 A1
(43) Pub. Date: Feb. 2, 2012

(54) Devices and Methods for Using HTTP Encapsulation to Access Web Resources

(76) Inventors: Swee Huat SNG, Torrance, CA (US); Weifeng Yao, Orange, CA (US)

(21) Appl. No.: 12/848,003

(22) Filed: Jul. 30, 2010

(51) Int. Cl. G06F 15/16; G06F 21/20

(52) U.S. Cl. 726/11; 709/203

(57) ABSTRACT

Embodiments provide a method of a system accessing web resources using HTTP encapsulation, by for example, a method that may include the steps of: (a) receiving, by an HTTP-encapsulator server component, HTTP request data from a web client; (b) saving, by the HTTP-encapsulator server, the HTTP request data; (c) creating, by the HTTP-encapsulator server, a first web resource accessible through an endpoint Uniform Resource Locator (URL); (d) creating, by the HTTP-encapsulator server, a second web resource containing data, wherein the data comprises: a URL to access the first web resource; and an endpoint URL pointing to a file handler on the HTTP-encapsulator server; (e) fetching, by an HTTP-encapsulator client of a local computing device, a command data of the HTTP-encapsulator server; (f) receiving, by the HTTP-encapsulator client, the command data of the HTTP-encapsulator server comprising a retrieval instruction to a data file stored at the local computing device as a destination page; (g) and generating, by the HTTP-encapsulator client, a response to the request of the HTTP-encapsulator server, based on a protected network resource; and (h) sending the generated response to the URL endpoint of the HTTP-encapsulator server hosted at the source external to the HTTP-encapsulator client of the local computing device.

### TECHNICAL FIELD

Embodiments pertain to systems and devices for, and methods of, HTTP encapsulation to access web resources.

### BACKGROUND

Computer resources may be hosted on a local device behind a network firewall from a remote host. The remote server may not be able to initiate outgoing HTTP connections to a Hypertext Transfer Protocol (HTTP) browser client on a local device residing within the firewall. An intermediary third-party server may be required to connect a client and server which are residing behind a network firewall from each other. Another method may implement persistent tunnel connections to be established between client and server.

### SUMMARY

Embodiments include methods, systems, and devices where, for example a method embodiment of a system accessing web resources using HTTP encapsulation may include the steps, not necessarily in the following order, of: (a) receiving, by an HTTP-encapsulator server component, HTTP request data from a web client; (b) saving, by the HTTP-encapsulator server, the HTTP request data; (c) creating, by the HTTP-encapsulator server, based on the request of the web client, a first web resource accessible through an endpoint Uniform Resource Locator (URL); (d) creating, by the HTTP-encapsulator server, a second web resource containing data, wherein the data comprises: a URL to access the first web resource; and an endpoint URL pointing to a file handler on the HTTP-encapsulator server; (e) fetching, by an HTTP-encapsulator client of a local computing device, a command data of the HTTP-encapsulator server; (f) receiving, by the HTTP-encapsulator client, the command data of the HTTP-encapsulator server comprising a retrieval instruction to a data file stored at the local computing device as a destination page; (g) generating, by the HTTP-encapsulator client, a response to the request of the HTTP-encapsulator server, based on a protected network resource; and (h) sending the generated response to the URL endpoint of the HTTP-encapsulator server hosted at the source external to the HTTP-encapsulator client of the local computing device. Optionally, the web client may be external to a local device behind a network firewall. Optionally, the second web resource may be a data file. Method embodiments may further comprise the step where the receiving of the HTTP request data from the web client is via a socket connection. In some embodiments the data may be optionally saved to a file. Some embodiments may include sending and receiving by the HTTP-encapsulator server of the request and response is via at least one of: HTTP GET and HTTP POST.

Embodiments include methods, systems, and devices where, for example a method embodiment of a server accessing web resources using HTTP encapsulation may include the steps of: (a) receiving, by an HTTP-encapsulator server component, an HTTP request data from a web client; (b) creating, by the HTTP-encapsulator server, based on the HTTP request data from the web client, a first web resource accessible through an endpoint URL; (c) creating, by an HTTP-encapsulator server, a second web resource containing data, wherein the data comprises: a URL to access the first web resource; and an endpoint URL pointing to a file handler on the HTTP-encapsulator server; (d) sending, by the HTTP-encapsulator server, a request to an HTTP-encapsulator client of a local computing device, wherein the request is via an HTTP GET by the HTTP-encapsulator client; (e) receiving, by the HTTP-encapsulator server, a response to the HTTP-encapsulator server's request, wherein the response is via an HTTP POST by the HTTP-encapsulator client; (f) generating, by the HTTP-encapsulator server, a binary file based on the received response to the sent request, wherein the HTTP-encapsulation is removed; and (g) sending the generated response to the web client. Optionally, the web client may be external to a local device behind a network firewall. Optionally, the second web resource may be a data file. Method embodiments may further comprise the step where the receiving of the HTTP request data from the web client is via a socket connection. In some embodiments the data may be optionally saved to a file.

Embodiments include methods, systems, and devices where, for example a method embodiment of a client accessing web resources using HTTP encapsulation may include the steps of: (a) polling, by an HTTP-encapsulator client of a local computing device, of an HTTP-encapsulator server component via an HTTP GET for HTTP command data; (b) receiving, by the HTTP-encapsulator client, a response to the command data from the HTTP-encapsulator server; (c) fetching, by the HTTP-encapsulator client, an HTTP request data from the HTTP-encapsulator server via an HTTP GET; (d) receiving, by the HTTP-encapsulator client, a response to the request data from the HTTP-encapsulator server, wherein the received request data is HTTP-encapsulated; (e) invoking, by the HTTP-encapsulator client, a call based on the request data; (f) sending, by the HTTP-encapsulator client, the response data to the HTTP-encapsulator server, wherein the response is HTTP-encapsulated and sent to the HTTP-encapsulator server via an HTTP POST; and (g) generating, by the HTTP-encapsulator server, a file, such as a binary file, based on the received response to the sent request, wherein the HTTP-encapsulation is removed. Optionally, the HTTP-encapsulator server is external to a local device behind a network firewall.

Embodiments pertain to server devices for accessing web resources using HTTP encapsulation, and the device embodiment may comprise: (a) a processor and (b) addressable memory, wherein the processor is configured to: (a) receive, by an HTTP-encapsulator server component, an HTTP request data from a web client; (b) create, by the HTTP-encapsulator server, a first web resource accessible through an endpoint URL; (c) create, by an HTTP-encapsulator server, based on the HTTP request data from the web client, a second web resource containing data, wherein the data comprises: a URL to access the first web resource; and an endpoint URL pointing to a file handler on the HTTP-encapsulator server; (d) send, by the HTTP-encapsulator server, a request to an HTTP-encapsulator client of a local computing device, wherein the request is via an HTTP GET from the HTTP-encapsulator client; (e) receive, by the HTTP-encapsulator server, a response to the HTTP-encapsulator server's request, wherein the response is via an HTTP POST from the HTTP-encapsulator client; (f) generate, by the HTTP-encapsulator server, a file, such as a binary file, based on the received response to the sent request, wherein the HTTP-encapsulation is removed; and (g) send the generated response to the web client.

Embodiments pertain to server devices for accessing web resources using HTTP encapsulation, and the device embodiment may comprise: (a) a processor and (b) addressable memory, wherein the processor is configured to: (a) poll, by an HTTP-encapsulator client of a local computing device, of an HTTP-encapsulator server component via an HTTP GET for HTTP command data; (b) receive, by the HTTP-encapsulator client, a response to the command data from the HTTP-encapsulator server; (c) fetch, by the HTTP-encapsulator client, an HTTP request data from the HTTP-encapsulator server via an HTTP GET; (d) receive, by the HTTP-encapsulator client, a response to the request data from the HTTP-encapsulator server, wherein the received request data is HTTP-encapsulated; (e) invoke, by the HTTP-encapsulator client, a call based on the request data; (f) send, by the HTTP-encapsulator client, the response data to the HTTP-encapsulator server, wherein the response is HTTP-encapsulated and sent to the HTTP-encapsulator server via an HTTP POST; and (g) generate, by the HTTP-encapsulator server, a file, such as a binary file, based on the received response to the sent request, wherein the HTTP-encapsulation is removed.

### BRIEF DESCRIPTION OF THE DRAWINGS

Embodiments are illustrated by way of example and not limitation in the figures of the accompanying drawings, and in which:

FIG. 1 depicts in a top-level functional block diagram an embodiment of a two-way communication established via an HTTP-encapsulation process;

FIG. 2A the flowchart of an exemplary process continued on FIG. 2B;

FIG. 2B the flowchart of an exemplary process continued from FIG. 2A;

FIG. 3 depicts in a top-level functional block diagram an embodiment of a client-server communication model via an HTTP-encapsulation process;

FIG. 4 illustrates an exemplary top level functional block diagram of an embodiment of a server computing device;

FIG. 5 is a flowchart of an exemplary server-side process;

FIG. 6 illustrates an exemplary top level functional block diagram of an embodiment of a client computing device;

FIG. 7A is a flowchart of an exemplary client-side process continued on FIG. 7B;

FIG. 7B is a flowchart of an exemplary process continued from FIG. 7A; and

FIG. 8 depicts in a top-level functional block diagram of a communication established via an HTTP-encapsulation process between client and server nodes.

### DETAILED DESCRIPTION OF THE DRAWINGS

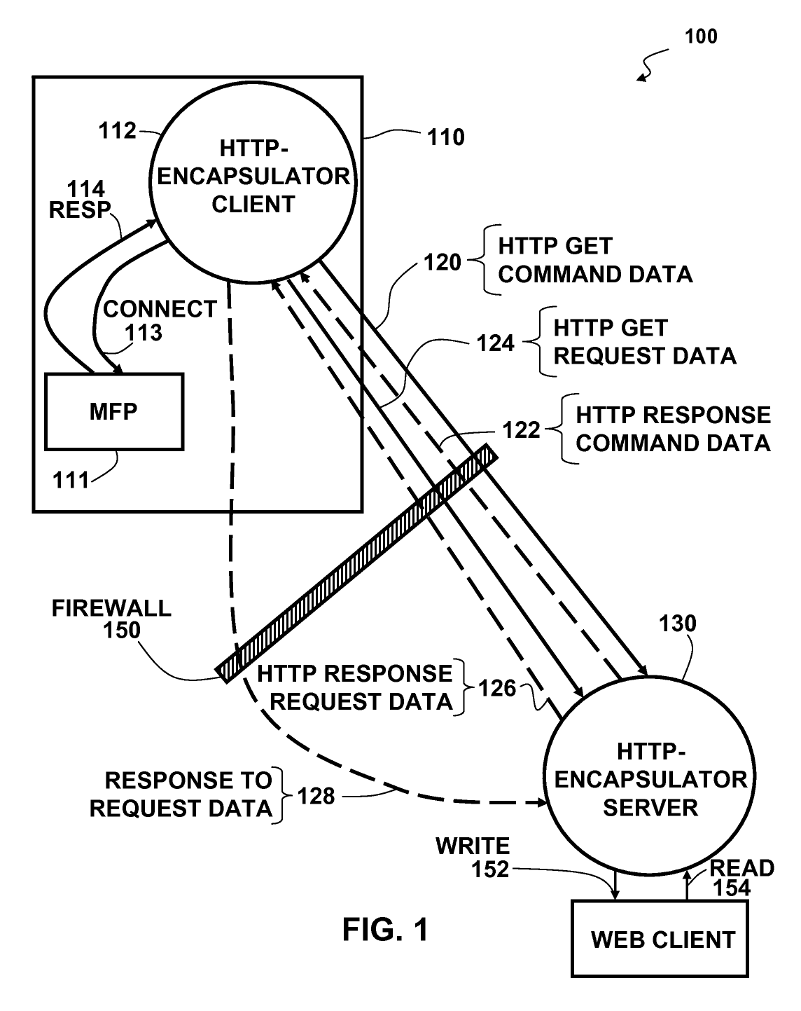

Reference is made to FIG. 1 illustrating an exemplary embodiment of the present invention. FIG. 1 depicts in a top-level functional block diagram, an embodiment of a two-way communication established via an HTTP-encapsulation process 100. A web client may communicate with an HTTP-encapsulator server 130 component via a socket connection and send data, e.g., HTTP requests, to the HTTP-encapsulator server 130. The HTTP-encapsulator server 130 component may reside on a trusted external network host whereby it communicates with an HTTP-encapsulator client 112 which may reside on a protected network resource, e.g., a multifunction peripheral (MFP) device 111. The web client may be deployed within a network environment where the MFP is ostensibly protected by a network firewall 150. The web client may connect to the MFP device 111 via a connection to the HTTP-encapsulator server 130. The HTTP-encapsulator server 130 may save the HTTP request data received from the web client via read 154 commands. The HTTP-encapsulator client 112 may periodically poll the HTTP-encapsulator server 130 for a command data. The HTTP-encapsulator client 112 may then retrieve a request data, e.g., retrieval instruction to a data file, from the HTTP-encapsulator server 130. The request data may then be sent from the HTTP-encapsulator client 112 to the MFP 111 via an HTTP connection. An HTTP connect 113 and HTTP response 114 may be used between the HTTP-encapsulator client 112 and the MFP 111. The HTTP-encapsulator client 112 may send the response data by, for example, saving it to a file and/or keeping it in the memory buffer. It then may send the entire response data to the endpoint URL via, e.g., uploading the file to the HTTP Encapsulation Server as an attachment 128. The HTTP-encapsulator server 130 may save the response data e.g., in the form of a binary file, and effectively removing the HTTP-encapsulation, before sending the response data to the web client through the already established socket connection.

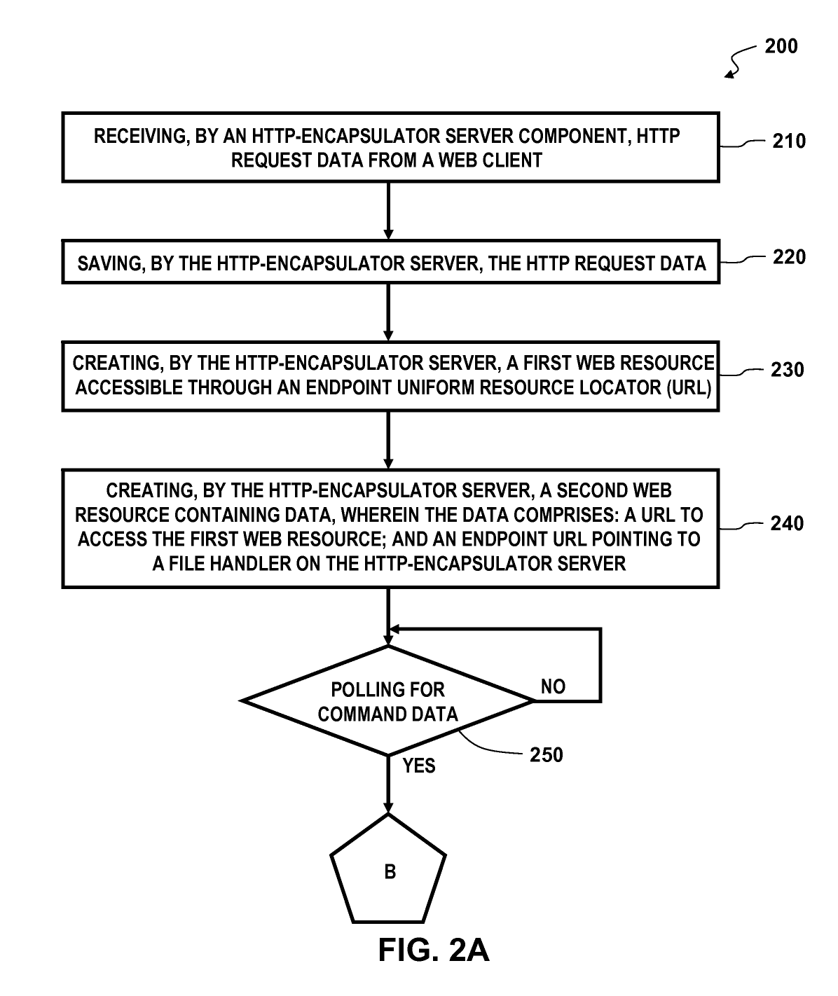

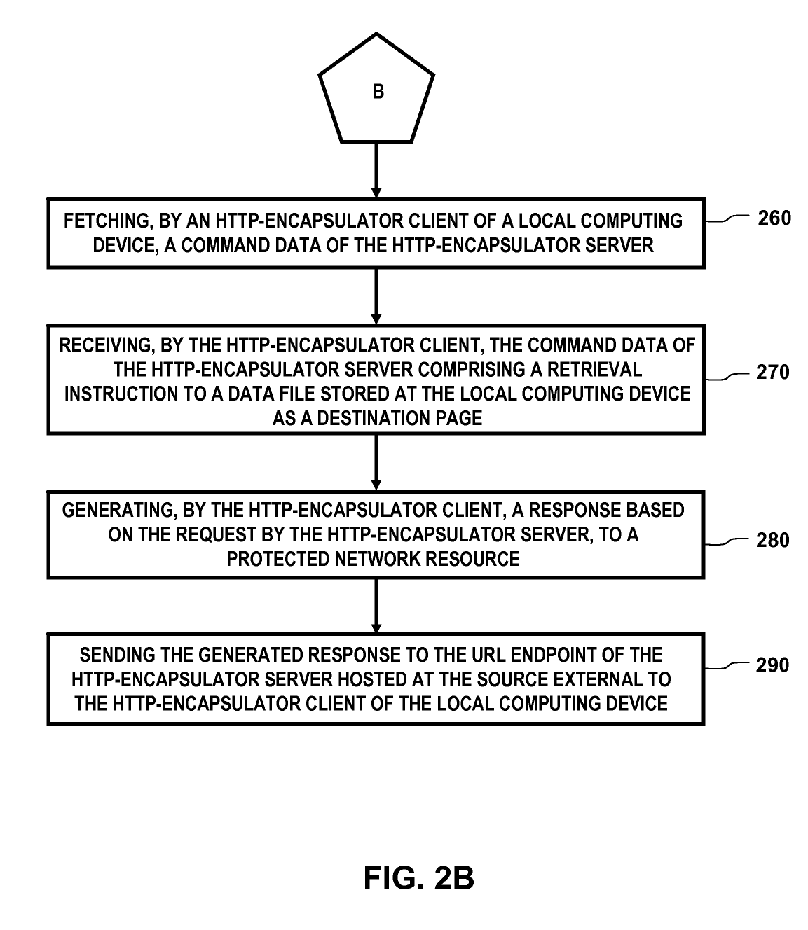

FIG. 2A is a flowchart of an exemplary process 200 in which the system comprises a computer and/or computing circuitry that may be configured to execute the steps as depicted. The method depicted in the flowchart includes the steps of: (a) receiving, by an HTTP-encapsulator server component, HTTP request data from a web client (step 210); (b) saving, by the HTTP-encapsulator server, the HTTP request data (step 220); (c) creating, by the HTTP-encapsulator server, a first web resource accessible through an endpoint Uniform Resource Locator (URL) (step 230); (d) creating, by the HTTP-encapsulator server, a second web resource containing data, wherein the data comprises: a URL to access the first web resource; and an endpoint URL pointing to a file handler on the HTTP-encapsulator server (step 240); and (e) polling based on the response to the command data, repeating if no data is available, otherwise continue to FIG. 2B step 260 if command data is retrieved (step 250).

FIG. 2B is a continuation of the flowchart of an exemplary process of FIG. 2A. The system is further configured to execute the steps as depicted in FIG. 2B. The method depicted in the flowchart includes the steps of: (f) fetching, by an HTTP-encapsulator client of a local computing device, a command data of the HTTP-encapsulator server (step 260); (g) receiving, by the HTTP-encapsulator client, the command data of the HTTP-encapsulator server comprising a retrieval instruction to a data file stored at the local computing device as a destination page (step 270); (h) generating, by the HTTP-encapsulator client, a response to the request of the HTTP-encapsulator server, based on a protected network resource (step 280); and (i) sending the generated response to the URL endpoint of the HTTP-encapsulator server hosted at the source external to the HTTP-encapsulator client of the local computing device (step 290).

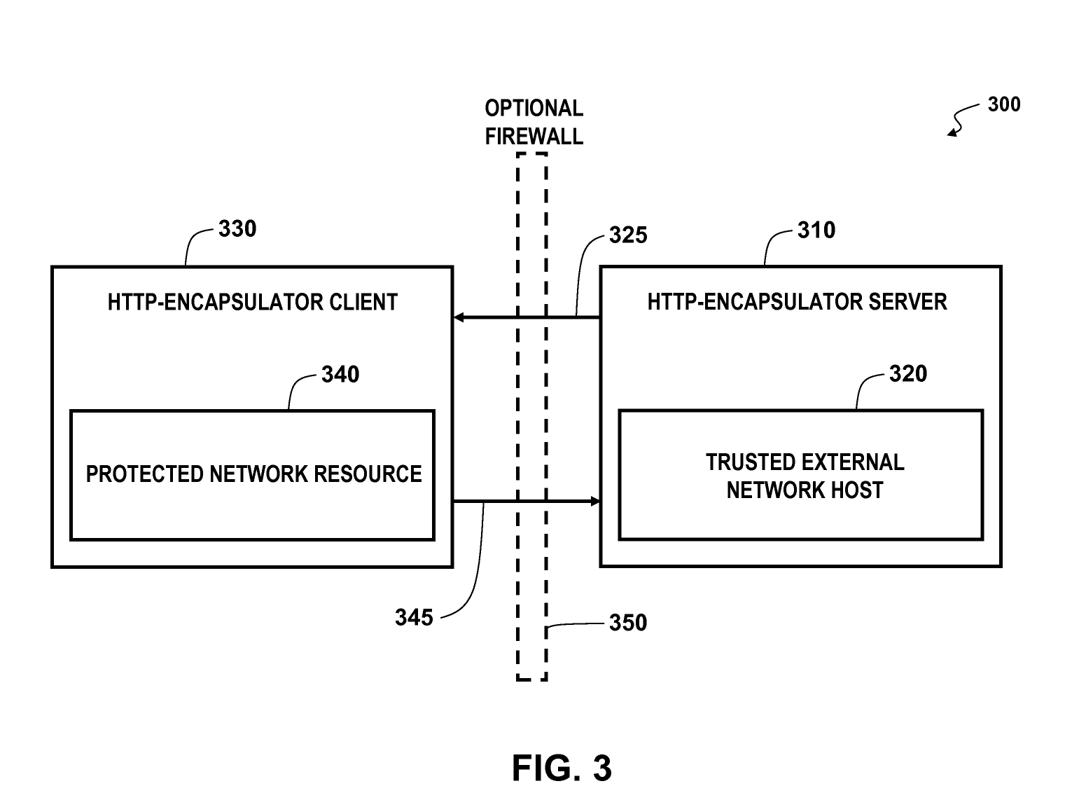

FIG. 3 depicts in a top-level functional block diagram an embodiment of a client-server communication model via an HTTP-encapsulation process 300. An HTTP-encapsulator server component 310 may reside on a trusted external network host 320 whereby it communicates with an HTTP-encapsulator client 330 which may reside on a protected network resource 340, e.g., a multifunction peripheral (MFP) device. The trusted external network host 320 may be deployed within a network environment where the protected network resource 340 is ostensibly protected by a network firewall 350. Embodiments may allow externally-hosted applications, e.g., web clients, to access functions on the protected network resource 340, e.g., an MFP device, that is protected by the firewall 350. The HTTP-encapsulator server 310 may access the protected network resource 340 via a connection 325 to the HTTP-encapsulator client component 330 that was initiated by HTTP encapsulator client 330 and request a command to be executed. The HTTP-encapsulator client 330 may send the response data by, for example, saving it to a file and/or keeping it in the memory buffer. It then may send the entire response data to the HTTP-encapsulator server, via the connection 345.

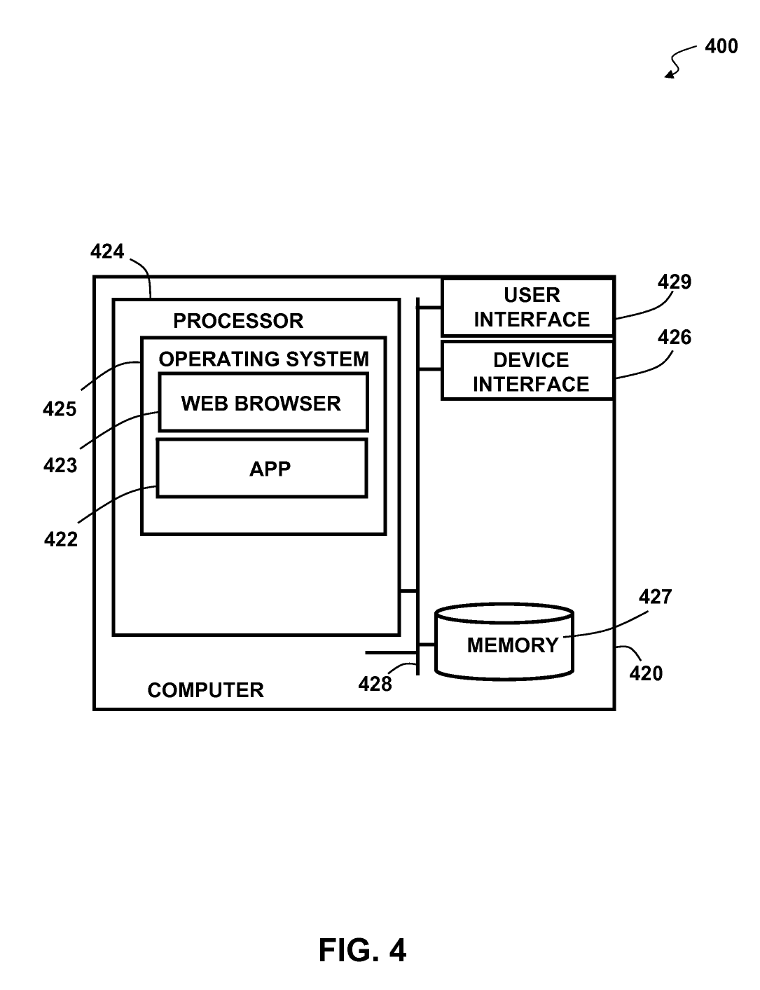

FIG. 4 illustrates an exemplary top level functional block diagram of a server computing device embodiment of the present invention. The exemplary operating environment is shown as a computing device 420 comprising a processor 424, such as a central processing unit (CPU), addressable memory 427, an external device interface 426, e.g., an optional universal serial bus (USB) port and related processing, and/or an Ethernet port and related processing, and an optional user interface 429, e.g., an array of status lights and one or more toggle switches, and/or a display, and/or a keyboard and/or a pointer-mouse system and/or a touch screen. These elements may be in communication with one another via a data bus 428. Via an operating system 425 such as one supporting a web browser 423 and applications 422, the processor 424 may be configured to execute steps of an HTTP-encapsulation method according to the exemplary embodiments described above.

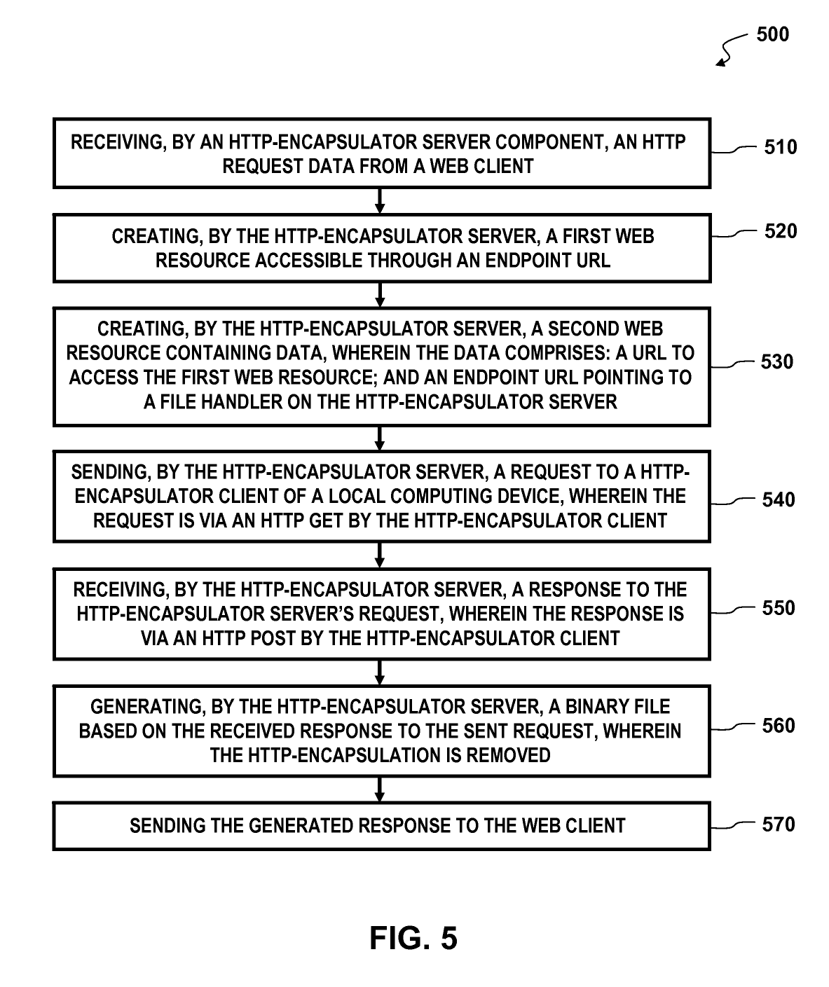

The HTTP-encapsulator server 500 comprises a computer and/or computing circuitry that may be configured to execute the steps of a server as depicted in FIG. 5. The method depicted in the flowchart includes the steps of: (a) receiving, by an HTTP-encapsulator server component, an HTTP request data from a web client (step 510); (b) creating, by the HTTP-encapsulator server, a first web resource accessible through an endpoint URL (step 520); (c) creating, by an HTTP-encapsulator server, a second web resource containing data, wherein the data comprises: a URL to access the first web resource; and an endpoint URL pointing to a file handler on the HTTP-encapsulator server (step 530); (d) sending, by the HTTP-encapsulator server, a request to an HTTP-encapsulator client of a local computing device, wherein the request is via an HTTP GET by the HTTP-encapsulator client (step 540); (e) receiving, by the HTTP-encapsulator server, a response to the HTTP-encapsulator server's request, wherein the response is via an HTTP POST by the HTTP-encapsulator client (step 550); (f) generating, by the HTTP-encapsulator server, a binary file based on the received response to the sent request, wherein the HTTP-encapsulation is removed (step 560); and (f) sending the generated response to the web client (step 570).

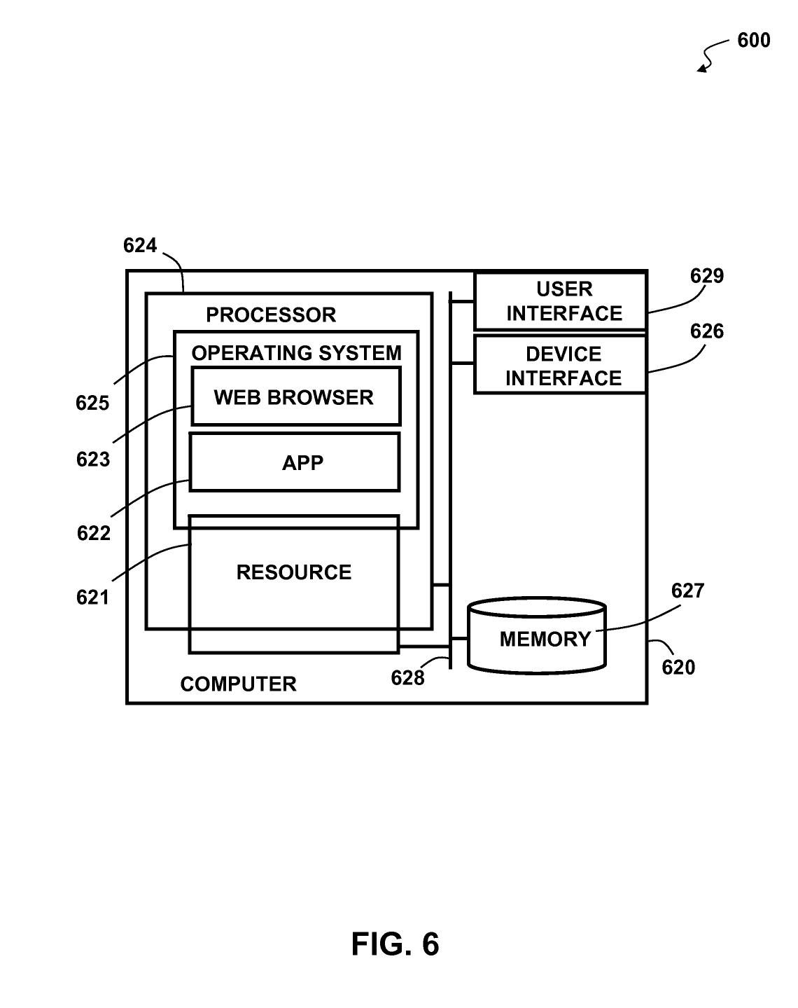

FIG. 6 illustrates an exemplary top level functional block diagram 600 of a client computing device embodiment of the present invention. To access a web resource, the HTTP-encapsulation may be executed via the HTTP-encapsulator client. FIG. 6 depicts a separate computing node as an alternative exemplary operating environment for the HTTP-encapsulation processing. The exemplary operating environment is shown as a computing device 620 comprising a processor 624, such as a central processing unit (CPU), addressable memory 627, an external device interface 626, e.g., an optional universal serial bus (USB) port and related processing, and/or an Ethernet port and related processing, and an optional user interface 629, e.g., an array of status lights and one or more toggle switches, and/or a display, and/or a keyboard and/or a pointer-mouse system and/or a touch screen. These elements may be in communication with one another via a data bus 628. Via an operating system 625 such as one supporting a web browser 623 and applications 622, the processor 624 may be configured to execute steps of an HTTP-encapsulation method to access a computer resource 621 according to the exemplary embodiments described above.

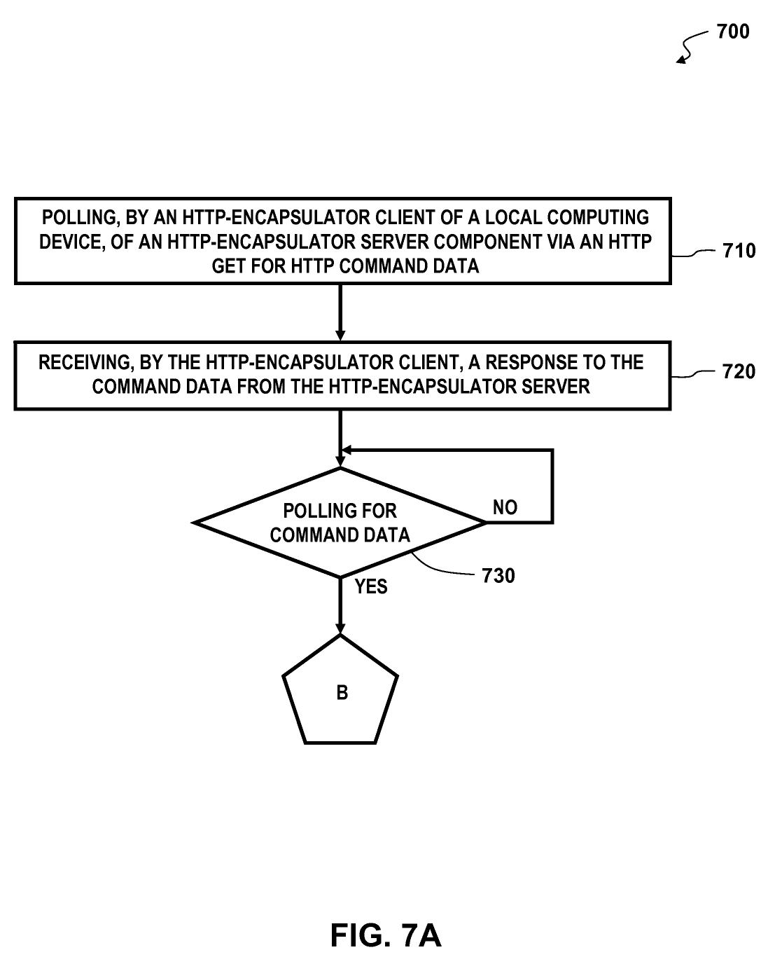

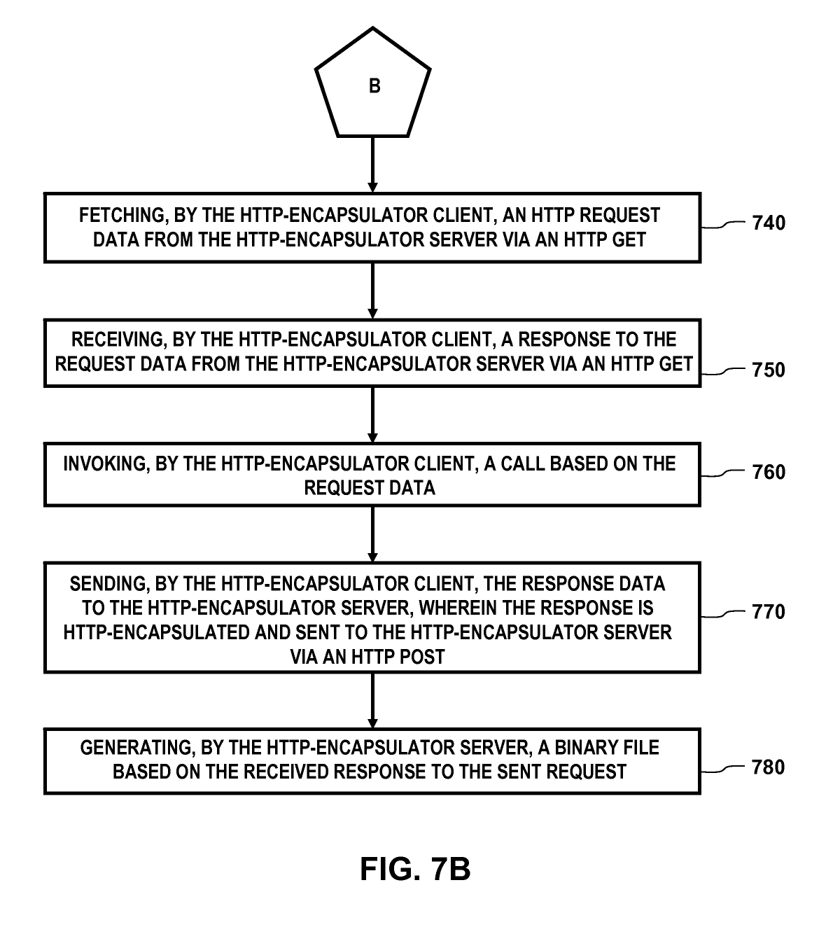

The local device, e.g., an MFP device behind the network firewall, comprises a computer and/or computing circuitry that may be configured to execute the steps of a client as depicted in FIG. 7A and continued on FIG. 7B. The method depicted in the flowchart includes the steps of: (a) polling, by an HTTP-encapsulator client of a local computing device, of an HTTP-encapsulator server component via an HTTP GET for HTTP command data (step 710); (b) receiving, by the HTTP-encapsulator client, a response to the command data from the HTTP-encapsulator server (step 720); (c) polling based on the response to the command data, where if no data is available then repeat, otherwise if command data is retrieved continue to the next step (step 730); (d) fetching, by the HTTP-encapsulator client, an HTTP request data from the HTTP-encapsulator server via an HTTP GET (step 740); (e) receiving, by the HTTP-encapsulator client, a response to the request data from the HTTP-encapsulator server, via an HTTP GET (step 750); (f) invoking, by the HTTP-encapsulator client, a call based on the request data (step 760); (g) sending, by the HTTP-encapsulator client, the response data to the HTTP-encapsulator server, wherein the response is HTTP-encapsulated and sent to the HTTP-encapsulator server via an HTTP POST (step 770); and (h) generating, by the HTTP-encapsulator server, a binary file based on the received response to the sent request (step 780).

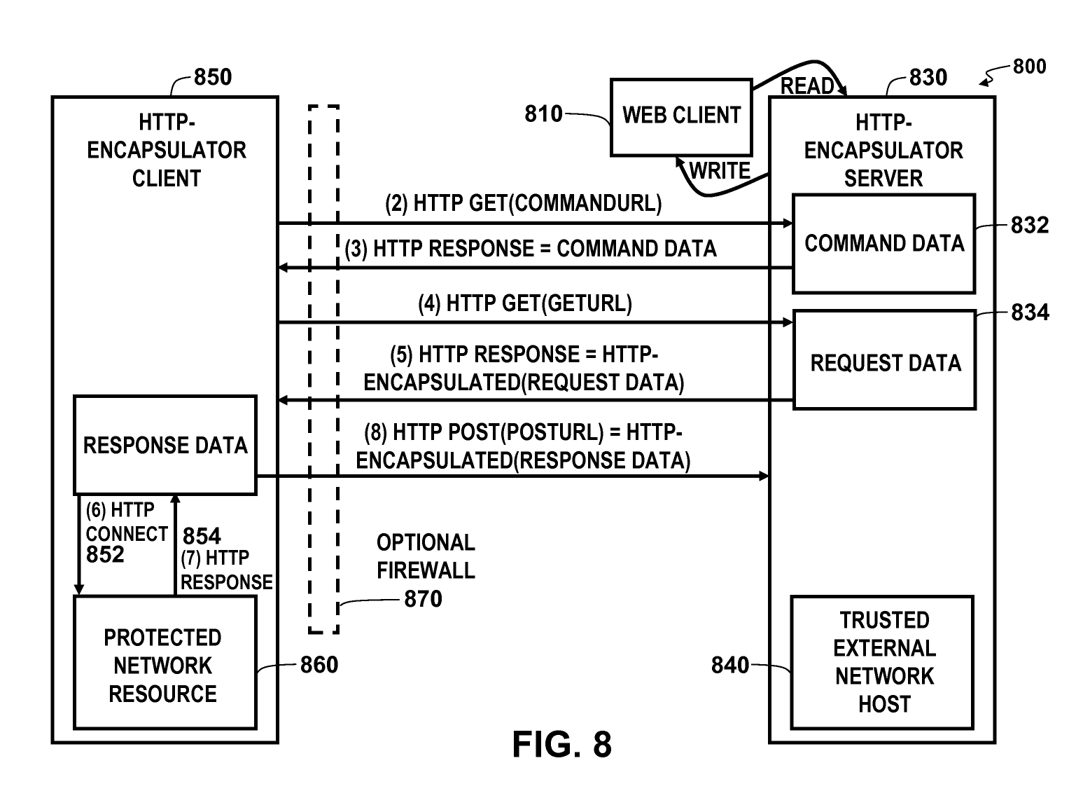

FIG. 8 depicts in a top-level functional block diagram an embodiment of a communication established via an HTTP-encapsulation process 800 between a client and server node. A web client 810 may communicate with an HTTP-encapsulator server 830 component via a socket connection and send data, e.g., HTTP requests, to the HTTP-encapsulator server 830. The HTTP-encapsulator server 830 component may reside on a trusted external network host 840 whereby it communicates with an HTTP-encapsulator client 850 which may reside on a protected network resource 860, e.g., a multifunction peripheral (MFP) device. The web client may be deployed within a network environment where the MFP is ostensibly protected by a network firewall 870.

The steps of an exemplary system operation may be characterized as follows: The web client 810 connects to the MFP device via a connection to the HTTP-encapsulator server component 830. The HTTP-encapsulator server 830 accepts a socket connection from the web client 810, and reads the HTTP request data sent from the web client 810. The HTTP-encapsulator server 830 saves the HTTP request data from the web client. The request data may be saved to a file, thereby creating a first web resource 834 (RequestData) that may be accessible through an endpoint URL. A second web resource 832 (CommandData) is created that may also be accessible through an endpoint URL. The second web resource is a data container that holds two URLs, e.g., GetURL and PostURL. GetURL is the URL to access the first web resource and PostURL is an endpoint URL that points to a file handler on the HTTP-encapsulator server 830. The file handler allows a standard HTTP POST of multipart-form format to upload files to the HTTP-encapsulator server 830.

The HTTP-encapsulator client 850 may be residing behind a firewall 870 and may be pre-configured to a valid CommandURL endpoint. At periodic intervals, the HTTP-encapsulator client 850 may make an HTTP GET request to the CommandURL endpoint. Upon retrieving a CommandData that contains GetURL and PostURL elements, the client may perform the steps of: (a) make an HTTP GET to the GetURL that retrieves the RequestData web resource, and effectively HTTP-encapsulates the RequestData in the HTTP response; (b) The HTTP-encapsulator client component then parses through ReqestData to determine the HTTP method, e.g., a set of at least POST, GET, PUT, or combination thereof, in the request. The necessary modifications are made to an HTTP header field e.g., “Host”, to ensure that the HTTP request is accepted by the target e.g., a protected web resource 860; (c) The HTTP-encapsulator client 850 makes an HTTP connection 852 to the protected network resource 860 and sends the modified RequestData. The protected web resource 860 may respond with an HTTP response 854. The HTTP-encapsulator client component either buffers in memory or saves to file the entire HTTP response (ResponseData). It then may make an HTTP POST to the PostURL, sending the ResponseData via, e.g., a file upload attachment. This serves to HTTP-encapsulate the ResponseData in the HTTP request. The HTTP-encapsulator server 830 file handler may save the attached ResponseData locally e.g., as a binary file. This serves to remove the HTTP-encapsulation on the ResponseData. The HTTP-encapsulator server component then sends the ResponseData to the web client through the established socket connection, thereby completing the entire web client HTTP request-response cycle.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. A method comprising:
creating, by the HTTP-encapsulator server, based on a request of a web client, a first web resource accessible through an endpoint Uniform Resource Locator (URL);
creating, by the HTTP-encapsulator server, a second web resource containing data, wherein the data comprises:
a URL to access the first web resource; and
an endpoint URL pointing to a file handler on the HTTP-encapsulator server;
fetching, by an HTTP-encapsulator client of a local computing device, a command data of the HTTP-encapsulator server;
receiving, by the HTTP-encapsulator client, the command data of the HTTP-encapsulator server comprising a retrieval instruction to a data file stored at the local computing device as a destination page;
generating, by the HTTP-encapsulator client, a response to the request of the web client received via the HTTP-encapsulator server, based on a protected network resource; and
sending the generated response to the URL endpoint of the HTTP-encapsulator server hosted at the source external to the HTTP-encapsulator client of the local computing device.

2. The method of claim 1 wherein the web client is external to a local device behind a network firewall.

3. The method of claim 1 wherein the second web resource comprises a data file.

4. The method of claim 1 wherein the receiving of the HTTP request data from the web client is via a socket connection.

5. The method of claim 1 wherein the data is saved to a file.

6. The method of claim 1 wherein sending and receiving by the HTTP-encapsulator server of the request and response is via at least one of: HTTP GET and HTTP POST.

7. A method comprising:
creating, by the HTTP-encapsulator server, based on an HTTP request data from a web client, a first web resource accessible through an endpoint URL;
creating, by an HTTP-encapsulator server, a second web resource containing data, wherein the data comprises:
a URL to access the first web resource; and
an endpoint URL pointing to a file handler on the HTTP-encapsulator server;
sending, by the HTTP-encapsulator server, a request to an HTTP-encapsulator client of a local computing device, wherein the request is via an HTTP GET by the HTTP-encapsulator client;
receiving, by the HTTP-encapsulator server, a response to the HTTP-encapsulator server's request, wherein the response is via an HTTP POST by the HTTP-encapsulator client;
generating, by the HTTP-encapsulator server, a binary file based on the received response to the sent request, wherein the HTTP-encapsulation is removed; and
sending the generated response to the web client.

8. The method of claim 7 wherein the web client is external to a local device behind a network firewall.

9. The method of claim 7 wherein the second web resource comprises a data file.

10. The method of claim 7 wherein the receiving of the HTTP request data from the web client is via a socket connection.

11. The method of claim 7 wherein the data is saved to a file.

12. A method comprising:
polling, by an HTTP-encapsulator client of a local computing device, of an HTTP-encapsulator server component via an HTTP GET for HTTP command data;
receiving, by the HTTP-encapsulator client, a response to the command data from the HTTP-encapsulator server;
fetching, by the HTTP-encapsulator client, an HTTP request data from the HTTP-encapsulator server via an HTTP GET;
receiving, by the HTTP-encapsulator client, a response to the request data from the HTTP-encapsulator server, wherein the received request data is HTTP-encapsulated;
invoking, by the HTTP-encapsulator client, a call based on the request data;
sending, by the HTTP-encapsulator client, the response data to the HTTP-encapsulator server, wherein the response is HTTP-encapsulated and sent to the HTTP-encapsulator server via an HTTP POST; and
generating, by the HTTP-encapsulator server, a binary file based on the received response to the sent request, wherein the HTTP-encapsulation is removed.

13. The method of claim 12 wherein the HTTP-encapsulator server is external to a local device behind a network firewall.

14. A server device comprising:
a processor and addressable memory, wherein the processor is configured to:
create, by the HTTP-encapsulator server, based on an HTTP request data from a web client, a first web resource accessible through an endpoint URL;
create, by an HTTP-encapsulator server, a second web resource containing data, wherein the data comprises:
a URL to access the first web resource; and
an endpoint URL pointing to a file handler on the HTTP-encapsulator server;
send, by the HTTP-encapsulator server, a request to an HTTP-encapsulator client of a local computing device, wherein the request is via an HTTP GET from the HTTP-encapsulator client;
receive, by the HTTP-encapsulator server, a response to the HTTP-encapsulator server's request, wherein the response is via an HTTP POST from the HTTP-encapsulator client;
generate, by the HTTP-encapsulator server, a binary file based on the received response to the sent request, wherein the HTTP-encapsulation is removed; and
send the generated response to the web client.

15. A client device comprising:
a processor and addressable memory, wherein the processor is configured to:
poll, by an HTTP-encapsulator client of a local computing device, of an HTTP-encapsulator server component via an HTTP GET for HTTP command data;
receive, by the HTTP-encapsulator client, a response to the command data from the HTTP-encapsulator server;
fetch, by the HTTP-encapsulator client, an HTTP request data from the HTTP-encapsulator server via an HTTP GET;
receive, by the HTTP-encapsulator client, a response to the request data from the HTTP-encapsulator server, wherein the received request data is HTTP-encapsulated;
invoke, by the HTTP-encapsulator client, a call based on the request data;
send, by the HTTP-encapsulator client, the response data to the HTTP-encapsulator server, wherein the response is HTTP-encapsulated and sent to the HTTP-encapsulator server via an HTTP POST; and
generate, by the HTTP-encapsulator server, a binary file based on the received response to the sent request, wherein the HTTP-encapsulation is removed.
